(19) United States
(12) Patent Application Publication
(10) Pub. No.: US 2020/0373855 A1
(43) Pub. Date: Nov. 26, 2020

(54) Electronic Wind Powered Generator

(71) Applicants: Richard L. Epstein, Santa Fe, NM (US); Victor Gerald Grafe, Corrales, NM (US)

(72) Inventors: Richard L. Epstein, Santa Fe, NM (US); Victor Gerald Grafe, Corrales, NM (US)

(21) Appl. No.: 16/872,146

(22) Filed: May 11, 2020

Related U.S. Application Data
(60) Provisional application No. 62/850,456, filed on May 20, 2019.
(60) Provisional application No. 62/859,355, filed on Jun. 10, 2019.

(51) Int. Cl. H02N 1/08; F03D 5/00

(52) U.S. Cl. CPC H02N 1/08; F03D 5/00

(57) ABSTRACT

Embodiments of the present invention can harvest wind energy based on the transport of air ions using Solid-State Wind-Energy Transformers (SWETs). These devices comprise coronal emitters that create charged air molecules. The charged air molecules are transported by wind to create useable electric power. SWETs can be deployed on existing structures, such as power-line poles or buildings, potentially eliminating much of the costs associated with other renewable energy systems.

### BACKGROUND

The present invention is related to the field of electrical energy generation, and specifically to the generation of electrical energy from wind-driven movement of charged particles.

Mechanical turbines have been enormously successful for converting wind energy to electrical energy, but this technology has well-known shortcomings: it requires large structures, has negative impacts on the environment, and requires maintenance. An alternate approach to harvesting energy from the wind is electrostatic or bladeless wind energy converters. See, e.g., Nowakowska, H., Lackowski, M., Ochrymiuk, T., and Szwaba, R., “Novel electrostatic wind energy converter: an overview”, TASK QUARTERLY, 19, No 2, pp. 207-218, (2015). Recent efforts have employed aerosols (typically water droplets) to carry the electrical charge. See, e.g., Carmein D., and White, D. 2013 “Electro-hydrodynamic wind energy system”, U.S. Pat. No. 8,421,047; Carmein D., White D. 2014 “Electro-hydrodynamic wind energy system”, U.S. Pat. No. 8,878,150; Djairam, D., “The Electrostatic Wind Energy Converter”, Ph.D. thesis Delft University of Technology (2008). Aerosol-based wind-energy converters have the advantage that the charged droplets couple strongly with air molecules and are readily transported by the wind. See, e.g., Marks, A. M. “Optimum Charged Aerosols for Power Conversion” J. Applied Phys. 43,219 (1972). However, aerosol-based technologies require continuous sprays droplets or particles, and this extra complexity adds to the cost and limits where these systems can be deployed. For example, a system based on water droplets can be problematic in freezing conditions.

An electrostatic energy converter that only uses charged air molecules or ions would, in principle, be easier to implement. Some early proposals suggested using air ions to harvest wind energy. See, e.g., Simon A 1935 Electrostatic generator, U.S. Pat. No. 2,004,352; Gregory A et al., Apparatus and Method of Generating Electricity from Wind Energy, U.S. Pat. No. 4,146,800. However, the relatively weak coupling of these ions to the wind was problematic, and no one was able to demonstrate net electrical power generation from winds.

### BRIEF DESCRIPTION OF THE DRAWINGS

FIG. 1 is a schematic illustration of an example solid-state wind-energy converter (SWET) with one wire of coronal emitters and two collector wires.

FIG. 2 is a schematic illustration of the energies and flows of the charge carriers in an example SWET.

FIG. 3 is an illustration of measurements of the ratios of the output to input powers and currents versus the effective wind velocities in an example SWET. The lines are just guides for the eye.

FIG. 4 is a schematic illustration of a commercial-scale SWET in which the generated power is fed into the power lines at regular intervals.

FIG. 5 is a schematic illustration of the physical principles of a solid-state wind energy transformer.

FIG. 6 is an illustration of the wiring of emitter and attractor wires.

FIG. 7 is a plot of

$${I}_{leak}^{\frac{1}{2}}$$

versus V_{load}.

FIG. 8, top, shows the net voltage Vₙₑₜ generated by the demonstration SWET versus the perpendicular wind velocities v_{wind} when the bias voltage is V_{load}=7 keV, and the load resistance is 5 GΩ. FIG. 8, bottom, shows the net power Pₙₑₜ for the same parameters.

FIGS. 9-21 provide schematic illustrations of example embodiments of the present invention.

### DESCRIPTION OF INVENTION

Embodiments of the present invention can harvest wind energy based on the transport of air ions using Solid-State Wind-Energy Transformers (SWETs). These devices comprise coronal emitters that create charged air molecules. The charged air molecules are transported by wind to create useable electric power. SWETs can be deployed on existing structures, such as power-line poles or buildings, potentially eliminating much of the costs associated with other renewable energy systems.

SWETs rely on air ions to carry electrical currents, and embodiments can be configured to exploit the relatively weak interaction between ions and the air. Both positive and negative air ions have a moderately high mobilities: μ=2.0×10⁻⁴ m² s⁻¹V⁻¹ and 2.7×10⁻⁴ m² s⁻¹V⁻¹, respectively. Chen, J. and Davidson, J. H., “Electron Density and Energy Distributions in the Positive DC Corona: Interpretation for Corona-Enhanced Chemical Reactions”, Plasma Chem. Plasma Process. 22, 199-224 (2002). In an electric field E these ions drift through the air with a velocity v_{drift}=με. In order for the wind to be able to move the ions and generate electrical power, embodiments are configured so that the wind velocity can be considerably greater than the drift velocity; i.e., v_{wind}>V_{drift}. This condition can be posed as a constraint on the electric field: for the SWET to work with a wind velocity v_{wind}, the electric field cannot be too strong; i.e., This is Equation 1

$$ɛ < \frac{{v}_{wind}}{μ} ∼ 22 ( \frac{{v}_{wind}}{10 mph} ) kV / m . \qquad ( 1 )$$

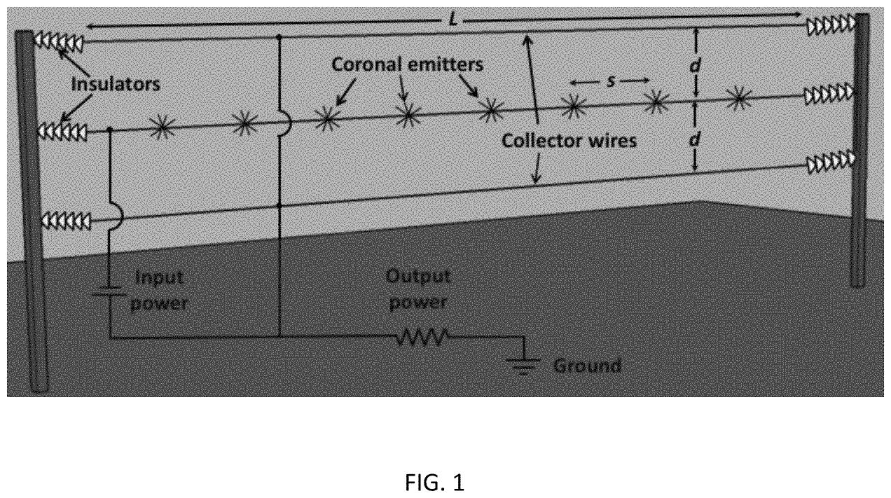

In an SWET system there are two sources of electric field: the field that is imposed to produce the coronal emission of charged ions, and the electric field that generates the output power. Both components of the field need to satisfy Eq. (1). FIG. 1 is a schematic illustration of an example SWET unit that uses three conducting wires. The wires are insulated from the supporting posts and separated from each other by distance d˜75 cm. A number of coronal emitters are attached to the middle wide with spacings s˜15 cm between them. The length of the three wires is L˜8 m. The coronal emitters are approximately 2-cm long tufts of carbon fibers with 7-micron diameters (Torayca T700G). A DC-DC converter (EMCO Q101N) provides the input power and energizes the top and bottom wires, the collector wires, to about 9.5 kV above the potential of the coronal emitters. This potential difference induces the emission of negative air ions from the coronal emitters. Some of these ions are captured by the collector wires and some are carried away by the wind and eventually settle to ground. The returning ground current generates the output power when it flows through the load, illustrated in the figure as a resistor. In use, the resister in the figure is replaced by electronics to send the output power for use elsewhere.

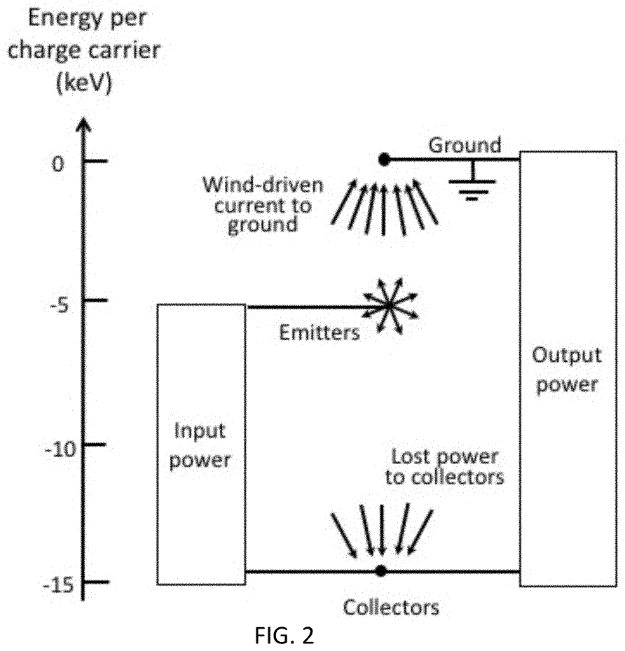

The operation of an SWET can be visualized by examining the energy of the charge carriers and the role of the wind, as illustrated in FIG. 2. The vertical scale gives the energy of the charge carriers, which are electrons and negative air ions in the current setup. In this figure, the input power extends over about 10 keV, corresponding to the output of the voltage converter. The output power extends about 15 keV, which is roughly the maximum voltage differential measure in the output resistor.

Negative air ions generated by the coronal emitters are pulled by the applied voltage toward the collector wires. If there is no wind, the ions simply lose potential energy as they drift to the collector wires. However, in the presence of wind, ions are carried away from the SWET apparatus. The ions carried by the wind do work against the electric field surrounding the SWET unit increasing their electrostatic potential energy. When the wind is sufficiently strong most of the air ions are blown from the SWET. The dispersed charges eventual settle to ground, and, in steady operation, they return to the SWET unit. The current flow through the load, represented by a resistor in FIG. 1, generates the output power.

An example SWET was built as a rooftop unit sketched in FIG. 1. An anemometer was attached to the unit to measure the wind speed and direction (AcuRite 01500 Weather Station). Measured voltage drops through 10 kΩ resistors give the input current (which flows through the voltage source) and the output current (which flow through the output resistor). The load resistance can be established so that the SWET device can generate net power. If the load resistance is too large, the output current is small compared to the input current. And, if the load resistance is too small, the output voltage is less than input voltage and the output power cannot exceed the input power. The example apparatus used load resistances of 10 and 15 GΩ.

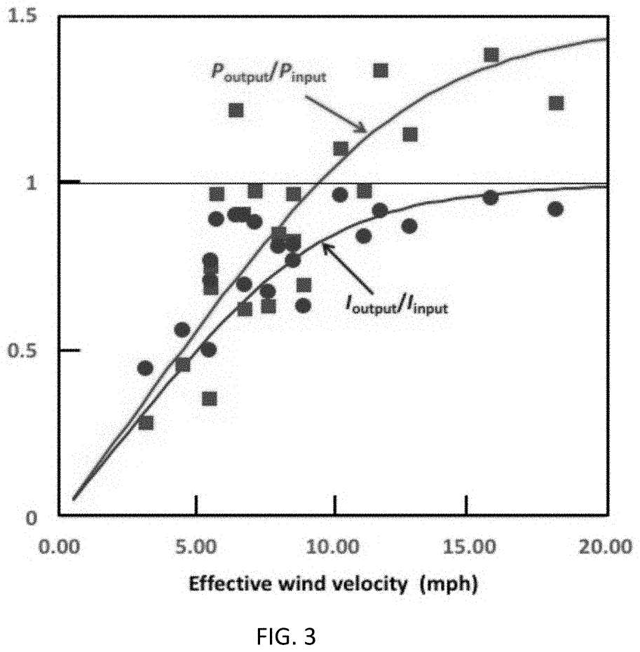

Some care is needed to correlate the SWET measurements with wind conditions. The rooftop wind in Santa Fe, N. Mex. where the example SWET unit was tested often fluctuates every few seconds in magnitude and direction. Additionally, the anemometer averages wind parameters over tens of seconds. To average over these effects, the wind speed and direction and the input and output currents were measured six times over about two minutes and averaged the results to obtain each data point. The effective wind velocity v_{eff}. characterizes the mean wind velocity perpendicular to the wires; v_{eff}=α(θ)v, was used, where v and 0 are the readings from the anemometer for the wind velocity and angle between the wind velocity and the normal to the wires, and α(θ) allows for the wind turbulence. The following prescription was used for α(θ): α(0)=1, α(22°)=1, α(45°)=0.87, α(60°)=0.71 and α(90°)=0.5. FIG. 3 shows the results of the SWET measurements taken over several days for varying weather conditions.

The blue circles in FIG. 3 show the ratio of the output to input currents. At low wind velocities, most of the ions are captured by the collector wires, and their energy is lost. For effective wind velocities above about 10 mph, the ratio of the output to input currents saturates near unity, indicating that most of the ions are carried away by the wind and eventually return to the SWET through the ground current. The red squares give the ratio of the output power to the input power; when this ratio is greater than unity, the SWET produces more power than it consumes. At higher wind velocities, the power yield was measured to be more than 40% greater than the input. These data are the first examples of net power production by an ion-based electrostatic wind-energy converter. In physical units, the input power for the measurement near 18 mph is 15.0 mW and the output power is 21.3 mW, giving a net power of 6.3 mW. Since the emitter wire is 8 m long, the net power production is about 0.79 W per km.

Large scale SWET units can be configured to have powers equal to and costs less than current wind turbines. Scaling up the power of the SWETs is straightforward, since multiple strands of emitter and collector wires can be strung between many structures; e.g., SWETs can be strung along power line poles, and there are many millions of km of power lines.

Decreasing the SWET cost per watt to levels competitive with existing wind turbines can involve tailoring of various parameters to the specific conditions. The cost of the SWET should be compared to the construction costs of conventional wind turbines, about $1/W. A significant cost of large-scale SWETs is the emitter wires; the collector wires carry relatively little current and can be thinner. In large volumes, the emitter wires can cost about $3/km. SWET units that produce more than 3 W/km of net power would therefore be cost competitive at installation with contemporary wind turbines (while still having the advantage of no moving parts and consequent reduced maintenance costs, and reduced impact on wildlife and the surroundings). Since the maximum power density of the demonstration unit was ^{˜}0.8 W/km, a power density improvement of about a factor of 4 would be sufficient to make an SWET directly competitive with contemporary wind turbines. The demonstration unit was not optimized for particular conditions, intended instead as a simple demonstration of the principles of operation. Other embodiments of the invention can increase the SWET power density significantly.

The power P_1 generated by an individual coronal emitter is space charge limited and depends on the voltages and spacing as { [symbol] P_1∝(V_emit−V_collect) [symbol] \hat{ }3}/d. Sigmond, R. S., “Simple approximate treatment of unipolar space charge dominated coronas: The Warburg law and the saturation current”, JAP, 53, 891 (1982). To increase the efficiency and power density of the SWETs, the input voltage, the load impedance and the distance between the emitter and collector wires can be adjusted to match the local conditions. As an example, the voltages and load impedance can be optimized in real time to accommodate variable wind conditions. The distance between emitter and collector wires can be determined based on average local conditions, and the variability available from adjustment of voltages and load impedance, to provide effective energy capture across a range of expected local conditions. Real-time adjustment of voltages and load impedance can also allow effective energy capture during unusually windy conditions, unlike mechanical turbines that must be deactivated in extreme conditions.

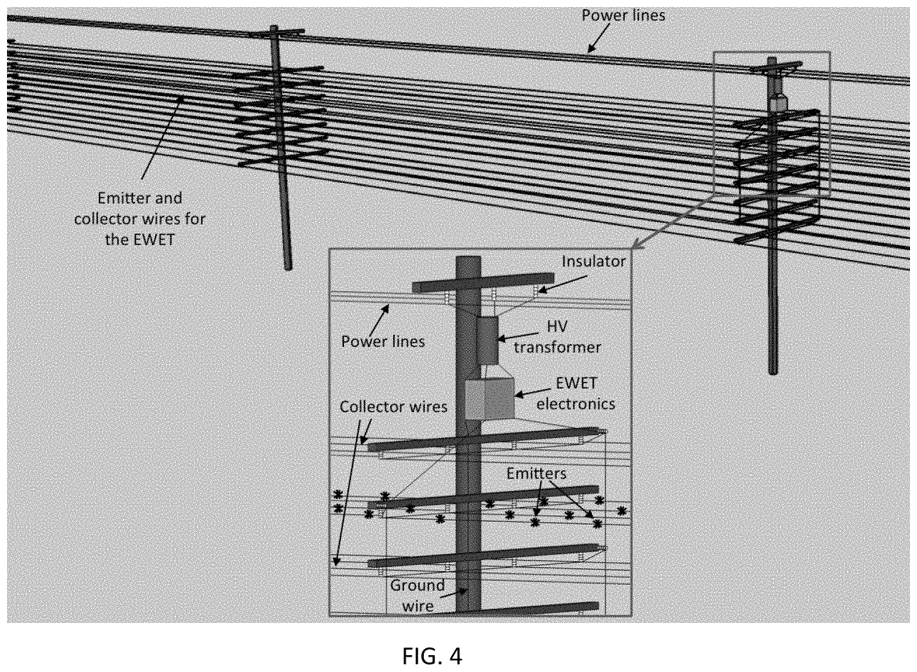

FIG. 4 is a schematic illustration of an example embodiment of commercial-scale SWET. A plurality of emitter and collector wires are strung parallel to power lines on existing poles. In this example embodiment there are 16 collector wires and 12 wires with emitters; other numbers are suitable. At regular intervals, the power from the SWET is added to that being carried by the power lines. An SWET electronics system is connected to the emitter wires, the collector wires and a ground wire. The SWET electronics system maintains the voltage bias between the emitters and the collector wires. It also acts as an inverter producing AC voltage from the load power. This power is fed into a high-voltage transformer, which adds the SWET power to that being transmitted by the power lines

The electric field in the example embodiment of FIG. 1 is proportional to the applied voltage divided by the spacing d. The example system can operate efficiently when the electric field is near the maximum allowable value given by equation (1). The spacing and applied voltage can be selected based on expected wind velocity, or on historical wind velocity in the region of the installation. Higher applied voltages suggest greater spacing. Higher wind velocity can allow smaller spacing, or larger applied voltage, or both. Generally, the load impedance can be matched to the impedance of the rest of the system. The load impedance can decrease as the power of the system increases.

The applied voltage or the load impedance, or both, can also be varied in response to current conditions. As an example, an SWET can shut down the applied voltage if the wind velocity is too low to generate net power above a determined threshold. As another example, the applied voltage can be increased responsive to increased wind velocity, and decreased with decreasing wind velocity. The applied voltage, load impedance, or both, can be varied periodically in response to average or expected conditions, for example responsive to local weather reports or predictions, or responsive to daily variations (night vs. day, as one example). They can also be varied in real time response to local measured conditions, for example responsive to measured wind velocity, or net power, or current differential. Varying responsive to measured conditions such as performance can provide the added benefit of compensating for wind velocity as well as changes in the emitters or collectors such as due to contamination or moisture. Time varying applied voltage or spacing can also be used to stimulate emission, then allow the wind to carry ions away before again stimulating emission, as described in the example below. The spacing can also be adjusted responsive to wind velocity, for example by using collector wires whose spacing is determined by wind acting on lift or drag of the wind on the wires. A plurality of emitters or collectors can be selectively energized responsive to changing wind direction.

The demonstration SWET system employs negative-ion emission (Chen, J., and Davidson, J. H., “Model of the negative DC corona plasma: comparison to the positive DC corona plasma”, Plasma Chemistry and Plasma Processing, 23, 83-102, (2003)); however, coronae that emit positive ions can be advantageous in some applications since positive ions have lower mobility. Chen, J. and Davidson, J. H., “Electron Density and Energy Distributions in the Positive DC Corona: Interpretation for Corona-Enhanced Chemical Reactions”, Plasma Chem. Plasma Process. 22, 199-224 (2002).

Example embodiments can use positive coronae, negative coronae, or a combination thereof. The differing ion mobility can be used in combination with spacing and applied voltage, as discussed above, to optimize performance or cost for local wind conditions. Positive coronae generally emit steadily, while negative coronae generally emit in bursts (Trichel pulses). Positive coronae can require higher voltages to initiate emission.

The power density can be enhanced by rapidly varying the applied voltage. Since the drifting ions take time to move from the emitter to the collector wires, variation of applied voltage can be used to enhance the emitted ion currents while still limiting those currents captured by the collectors. For example, in the demonstration unit the time for the ions to drift from the emitters to the collector wires is tens of ms. The ion production can be greatly increased by tripling the bias voltage between the emitters and collector wires to, for example, 30 kV, for about 10 ms and then cutting it back for 50 ms to allow the wind to carry the ions far from the SWET.

The choice of material for the coronal emitters can also enhance the power density. As an example, carbon nanotube emitters, with their smaller diameters, can allow ion emission at lower fields and might help in the design of cost-effective SWET devices.

The example embodiment shown uses parallel emitter and collector wires for simplicity of illustration and ease of testing. Other geometries and arrangements can also be suitable, including as examples zig-zag configurations to accommodate varying wind directions; horizontal, vertical, or a combination of configurations responsive to wind conditions and site requirements; sheets, plates, or curved surfaces for emitters, collectors, or both; and meshes and mesh-like structures for emitters, collectors, or both. Emitter and collector subsystems can be configured to use existing structures, or to be mounted with existing structures, to reduce costs. Insulators or partial insulators can be mounted between emitters and collectors in some embodiments to reduce ion drift to collectors and allow transport by wind.

A solid-state apparatus with no moving parts can harvest electrical power from the wind. Embodiments of the present invention provide a Solid-state Wind-Energy Transformer (SWET) uses coronal discharge to create negative air ions, which the wind then transports away from the SWET. The SWET harnesses the wind-induced currents and voltages to produce electrical power. We report on the operation of a low-power, proof-of-concept SWET. An example device comprises a number of parallel electrical wires: emitter wires, which have numerous, sharp coronal emitters attached to it, and bare attractor wires. When a negative bias voltage is applied to the emitter wires relative to the attractor wires, the coronal emitters generate negative ions. The wind carries off these ions, and they eventually settle to ground. The power imparted to the ions by the wind is extracted from the current returning to the SWET from the ground. This low-power SWET is the first device to generate net electrical power from the wind using only air ions. SWET can be scaled up to commercially interesting powers by increasing the number and length of the emitter and attractor wires. By mounting the SWET wires on existing structures (building, bridges, power line towers, etc.) the deployment costs can be minimized so that SWETs could produce large amounts of electrical power at low costs with little negative environmental impact.

The generation of airflows by ionic currents, electrohydrodynamics, is well studied and has numerous applications, even including airplane flight. The reverse process, using airflows to create ionic currents, has received much less attention. Up to now, no one has generated net electrical power with wind-driven ionic currents. The barrier for producing electrical power by this process is due to the high mobility of air ions: the mobility problem. Electric fields pull the ions through the neutral air, creating drift currents that tend to short-out the voltages generated by the wind-driven currents. This mobility problem can be overcome if the apparatus is designed to that the electric fields are sufficiently weak, allowing the wind to largely control the ion motion.

REPEATING FROM LINE [03] The traditional approach for producing electrical power from the wind via mechanical turbines has well-known shortcomings: wind turbines require massive supporting structures and regular maintenance. Additionally, they are highly visible, generate noise and negatively impact some wildlife. Tests of example embodiments of the present invention demonstrate that the harvesting of wind energy through wind-driven ionic currents can be a cost-effective and environmentally benign technology that avoids these problems.

The SWET described here is a type of electrostatic wind energy converter (EWEC). EWECs generate electrical power when the wind moves charges. Recent efforts in EWECs employ aerosols (typically water droplets) to carry the electrical charge. Aerosol-based EWECs have the advantage that the charged droplets couple strongly with the air and are readily transported by the wind, mitigating the mobility problem. However, aerosol-based devices require continuous sprays of droplets or particles, and this extra complexity adds to their costs and limits their usefulness. For example, a system based on water droplets would be problematic in freezing conditions.

An EWEC that uses only charged air molecules or air ions can be less complicated and more reliable. However, early suggestions for ion-based EWECs had not led to any demonstration of net electrical power generation. The performance of an ion-based EWEC, a Solid-State Wind-Energy Transformer (SWET), that produces net electric power, is described herein. This unit demonstrates that there are no physics barriers to using negative air ions to produce electrical power from the wind. The simplicity of this low-power apparatus shows that SWETs could be scalable to commercially interesting powers.

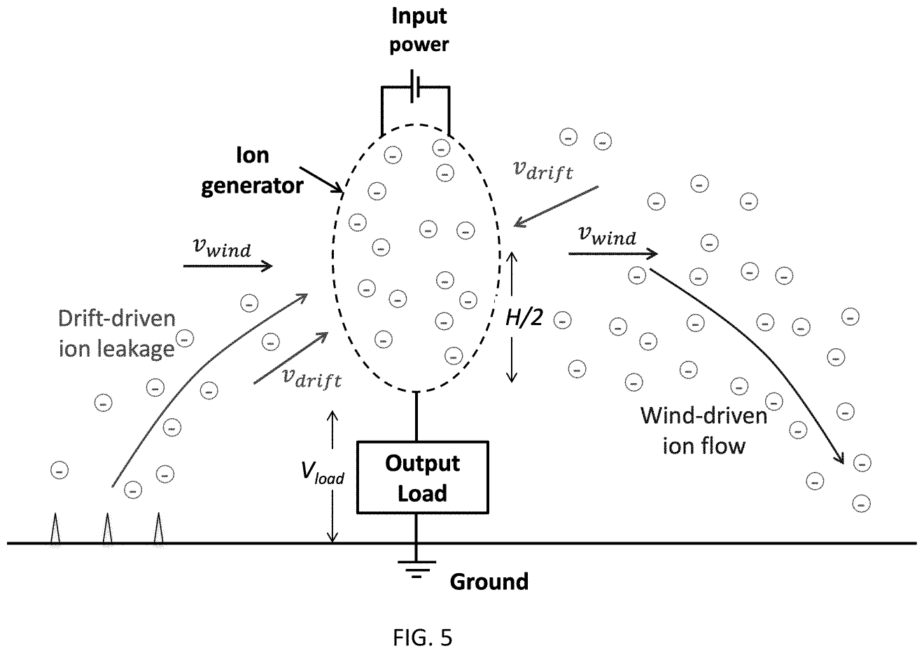

The general principles of a SWET are illustrated in FIG. 5. The oval in the center of the figure represents the ion-generator portion of the SWET. The ions are produced by coronal discharges, which requires some input power, as indicated. To produce net power, the wind-generated power has to exceed that expended in producing the air ions. The negative air ions (show by green circles with minus sign) are carried off by the wind, eventually settling to ground. The removal of negative charge from the SWET hardware leaves behind a positive charge and hence a positive voltage V_{load} relative to ground. The returning (negative) ground current passes through the output load, generating the useful electrical power.

Ion leakage, indicated in the lower left of the figure, decreases the energy generation in SWETs. When V_{load} becomes large, various points or irregularities on the ground (represented by the triangles on the lower-left of the figure) produce negative air ions by coronal emission. These ion drift to the SWET, creating leakage currents that partially short-out V_{load} and limit the generation of useful power.

To understand how the mobility problem affects the SWET, consider the electric field just outside the ion generator. An ion generator at voltage V_{load} produces an electric field of magnitude

$$E ∼ \frac{2 {V}_{load}}{H}$$

that opposes the removal of the ions; here H is the characteristic length scale of the ion-generator. The drift velocity v_{drift} of the ions toward the SWET is v_{drift}=μE, where μ is the mobility for negative air ions; μ=2.7×10⁻⁴ m² s⁻¹ V⁻¹. In order for the SWET to generate power, the wind velocity v_{wind} must be strong enough to overpower this drift of the ions through the air; that is, the wind velocity must be significantly larger than the drift velocity. The condition v_{wind}>v_{drift} gives an upper limit on the voltage induced by the wind:

$${V}_{load , hlx} = \frac{H {v}_{w i n d}}{2 μ} = 1.9 H {v}_{w i n d} kV \qquad ( 2 )$$

where H is in meters and v_{wind} is in m/s.

To test the basic concepts of SWETs, we built and characterized a low-power, proof-of-concept unit. The ion-generator portion of the unit consists of 55 parallel, 17-gauge, aluminum wires strung between two 8.5-m tall wooden masts, separated by about 8 m on a flat roof. All the wires are well insulated from the masts. Twenty of the wires, the emitter wires, have small tufts of 7-micron diameter carbon fibers (Torayca T700G) attached about every 15 cm. These small diameter fibers act as coronal emitters. The other 35 wires, the attractor wires, are bare. To produce negative ions, the emitter wires are biased by a negative voltage V_{bias} relative to the attractor wires. When V_{bias} is large enough, the strong electric fields that form at the tips of the carbon fibers produce coronal emission, generating negative air ions.

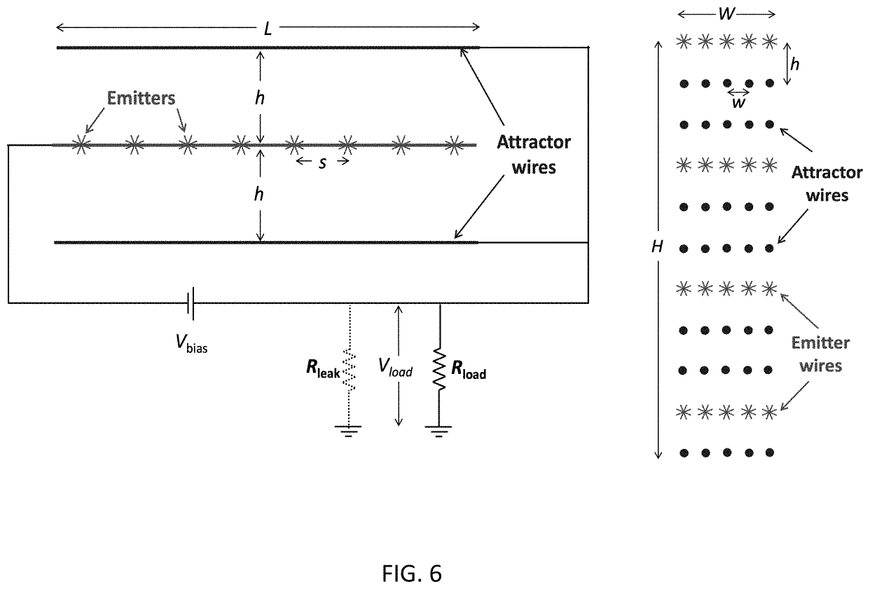

FIG. 6 is an illustration of the wiring of emitter and attractor wires. The left panel shows spacing s of emitters on the emitter wires and the separation h between adjacent emitter and attractor wires. The right panel shows the arrangement of the 20 emitter and 35 attractor wires. The low-power SWET uses h=50 cm, w=25 cm, s˜15 cm, and L=7 m.

The left side of FIG. 6 shows the wiring for one emission wire and the two adjacent attractor wires. A battery-powered Ultra Volt 40A12-N4 power supply biases the emitter wires relative to the attractor wires. The base of this power supply floats at the voltage of the attractor wires and is electrically isolated from ground. The resistance R_{load} is a proxy for the output load; the power dissipated in R_{load} represents the output power. The resistance Rₗₑₐₖ (shown in dotted line) represents the path of the unavoidable leakage current.

The right side of FIG. 6 shows the arrangement of the 55 wires of the low-power SWET unit. We found that having two attractor wires between each pair emitter wires, rather than one, produced more power. Many other wire arrangements can be suitable, and the arrangement can be optimized based on, inter alia, local characteristics, available materials, and desired performance.

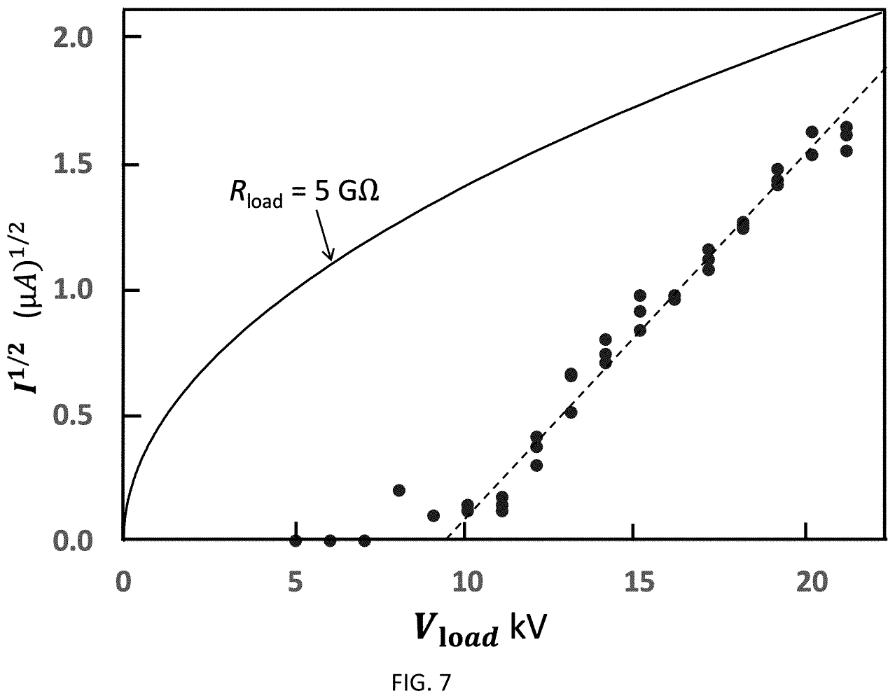

We measured the leakage current Iₗₑₐₖ by applying voltages to the attractor wires while the load circuit was open (R_{load}=co). FIG. 7 is a plot of Iₗₑₐₖ^{1/2} versus V_{load}. The straight dashed line shows that the leakage current increases approximately quadratically with V_{load} above a threshold of around 10 kV; this quadratic increase suggests that the leakage current is due to coronal emission rather than some conductive path. The solid curve shows the load current that flows through the 5 GΩ resistor that is used for R_{load} in the low-power SWET. We see that for V_{load}<20 kV, the leakage current is relatively small compared to the load current. At higher load voltages, the leakage current seriously impairs the operation of this low-power SWET. In a high-power SWET, the load current would be larger, and the leakage current is expected to be relatively less important.

The bias voltage V_{bias} has to be set large enough to generate coronal emission, but small enough so that the ions can escape the SWET. We find that for h=0.5 m, a voltage of several kV is sufficient to generate coronal emission. The average electric field between the emitter and attractor wires is [symbol] E_{bias} [symbol] =V_{bias}/h. The wind can pull the ions out of the SWET if v_{wind}>μ [symbol] E_{bias} [symbol] or

$${v}_{w i n d} > \frac{μ {V}_{bias}}{h} = 3.8 ( \frac{{V}_{bias}}{7 kV} ) {( \frac{h}{0.5 m} )}^{- 1} \frac{m}{s} \qquad ( 3 )$$

This condition sets a threshold wind velocity for the operation of the low-power SWET.

To characterize the performance of the low-power SWET, we measured the current emitted in negative ions Iₑₘᵢₜ and the return current I_{load} through a 5 GΩ load resistor for various wind speeds. The bias voltage was set at V_{bias}=7 kV, and the wind velocity is measured with an AcuRite 02064 Wireless Weather Station.

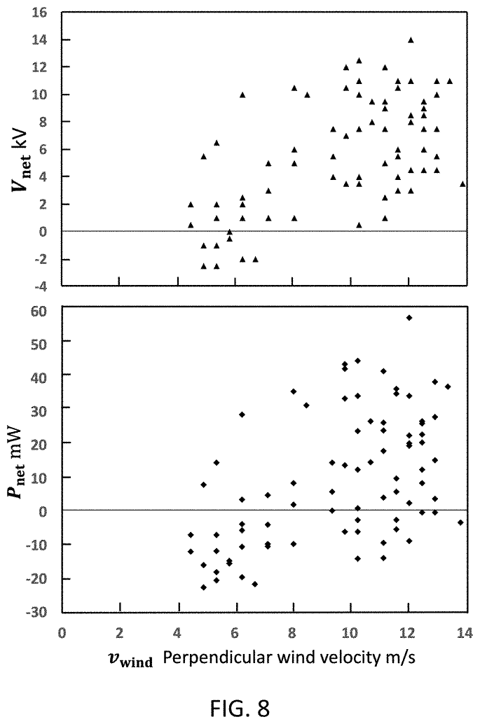

FIG. 8, top, shows the net voltage Vₙₑₜ generated by the demonstration SWET versus the perpendicular wind velocities v_{wind} when the bias voltage is V_{load}=7 keV, and the load resistance is 5 GΩ FIG. 8, bottom, shows the net power Pₙₑₜ for the same parameters. The net voltage generated by the SWET is the load voltage minus the bias: Vₙₑₜ=V_{load}−V_{bias}. The top of FIG. 8 shows measurements of Vₙₑₜ against the wind velocity perpendicular to the SWET wires. Since the winds were generally gusty, the data are necessarily noisy. This small, proof-of-concept device readily produced load voltages several times the bias voltage. The lack of positive values of Vₙₑₜ at low wind velocities is due to capture of the negative ions by the attractor wires near or below the threshold wind velocity given by Eq. 3. The paucity of voltages above Vₙₑₜ=13 kV can be attributed to the leakage currents; when V_{load}=Vₙₑₜ V_{bias} exceeds about 20 kV, the leakage current becomes significant compared to the load current (see FIG. 7).

The net power generated by the low-power SWET is the power deposited in the load resistor minus that required to produce the negative air ions:

$${P}_{n e t} = \frac{{V}_{load}^{2}}{{R}_{load}} - {I}_{emit} {V}_{bias} \qquad ( 4 )$$

where Iₑₘᵢₜ is the total current emitted as negative ions. We ignore the inefficiencies in the power source, since they could be mitigated by using highly efficient power electronics. The bottom of FIG. 4 shows Pₙₑₜ versus the perpendicular wind velocity. These are the first reported measurements of net power generation by wind-driven air ions.

This low-power, proof-of-concept SWET shows that wind-driven air ions can generate electric power. Since the main components of the SWET are simply parallel emitter and attractor wires, the SWET concept should be scalable to much higher powers by increasing the number and length of the wires. A high-power SWET would have much lower load impedance, so that the leakage current would be expected to be relatively unimportant. Also, increasing the effective scale H creates larger net voltages; see Eq. 2.

The cost of deploying high-power SWETs can be reduced by suspending the emitter and attractor wires from existing structures. For example, the wires of high-power SWETs can be supported by transmission towers, buildings, bridges, etc. SWET wires can even be attached to wind-turbines supports in wind farms to augment the power generation. Since the electrical current in the individual emitter and attractor wires is small, high-power SWETs can use inexpensive, small-diameter steel wires without generating significant ohmic losses.

The power that can be produced by the high-power SWET is roughly equal to the wind-induced voltage V_{load} times the total current produced by all the emitter wires; the input power should be relatively small and can be neglected in these estimates. To assess of the available power in high-power SWETs, we consider a large network of emitter and attractor wires similar to that indicated in FIG. 6, but with larger overall dimensions and smaller spacings; i.e., s«h and w«h.

The emitted ion current density is the charge density times the ion velocity. If we first neglect the effects of the wind, the currents drifting from the emitter wires to the attractor wires current is largely one dimensional except near the individual emitters, where the equipotential surfaces sharply curve around the tips of the emitters. The current density Jₑₘᵢₜ per unit area in much of the region between the emitter wires and the attractor wires is thus

Jₑₘᵢₜ=ρv_{drift,bias}=ρμE_{bias}, (5)

where ρ is the charge density.

The bias voltage is

$${V}_{b i a s} = {\int }_{0}^{h} {E}_{b i a s} d z \qquad ( 6 )$$

The charge density is given by Poisson's equation:

$$ρ = {ɛ}_{0} \frac{d {E}_{b i a s}}{d z} \qquad ( 7 )$$

where ε₀ is the vacuum permittivity.

Since Jₑₘᵢₜ is independent of the distance z from the emitter wires, the solution to these equations is

$$\begin{matrix}{E}_{b i a s} = \frac{3 {V}_{b i a s}}{2 h} {( \frac{z}{h} )}^{\frac{1}{2}} \\ and & ( 8 ) \\ {J}_{e m i t} = \frac{9 {ɛ}_{0} μ {V}_{{b}_{1 \partial S}}^{2}}{8 {h}^{3}} & ( 9 )\end{matrix}$$

This estimate of the current density in the absence of wind gives a lower limit to the actual current density. When the wind velocity is comparable or bigger that the drift velocity V_{drift,bias}, the charged ions escape more quickly than indicated in Eq. (5), so that the current density to be greater than that given by Eq. (9). To be conservative, we ignore this wind-induced current enhancement. The total current produced by a high-power SWET is the total effective area of emitters times current density Jₑₘᵢₜ given by Eq. 9. For a high-power SWET of width W, height H and length L the total area of emitters producing is Aₜₒₜ=(2/3)WHL/h, and the total current is I_{SWET}=AₜₒₜJₑₘᵢₜ.

We take the load voltage to be V_{load}≡αV_{load,max}, where α is a voltage efficiency factor. By comparing equation Eq. (2) with the upper panel of FIG. 4, we estimate that α˜0.2 for the low-power SWET. In an optimized high-power SWET, the bias voltage V_{bias} would set to be as large as possible, to maximize the current density Jₑₘᵢₜ, while still being small enough so that the negative air ions could escape the SWET; i.e.,

$${V}_{b i a s} ∼ \frac{{v}_{w i n d} h}{μ}$$

(see Eq. 2). With this estimate for V_{bias}, the power of a high-power SWET is P_{SWET}=I_{SWET}V_{load}:

$${P}_{SWET} = \frac{3 α {ɛ}_{0} {v}_{w i n d}^{3} W {H}^{2} L}{8 {h}^{2} {μ}^{2}} = 200 {α ( \frac{{v}_{w i n d}}{10 m / s} )}^{3} {( \frac{h}{0.5 m} )}^{- 2} ( \frac{W}{5 m} ) {( \frac{H}{15 m} )}^{2} ( \frac{L}{km} ) kW \qquad ( 10 )$$

The high-power SWET generates a moderate amount of power per km. If a were only 20%, the SWET would generating about 40 kW per km (for the fiducial dimensions of Eq.10). To produce MWs of power, this SWET system would have to stretch over many km. This type of extended power source could provide opportunities for balancing the power generation in response to local weather conditions or power requirements.

The estimate of P_{SWET} in Eq. 10 assumes that the SWET does not significantly impede the wind flow. This assumption is valid if the SWET extracts only a small fraction of the available wind power. The available power density in the wind is limited by mass and energy conservation to the Betz limit [12]: P_{Betz}=(8/27)ρv_{wind}³. Comparing the Betz limit with Eq. 10 gives the constraint

$$\frac{{P}_{S W E T}}{{P}_{B e t z}} ∼ 0.04 {α ( \frac{h}{0.5 m} )}^{- 2} ( \frac{W}{5 m} ) ( \frac{H}{15 m} ) ≪ 1 \qquad ( 11 )$$

For dimensions near the fiducial values considered here, this condition is well satisfied.

The following references, each of which is incorporated by reference herein, can facilitate understanding of the present invention.
Fylladitakis, E. D., Theodoridis, M. P., and Antonios X. Moronis, A. X., “Review on the History, Research, and Applications of Electrohydrodynamics” IEEE Transactions on Plasma Science, 42, 358-375, (2014)
Xu, H., He, Y., Strobel, K. L., Gilmore, C. K., Kelly, S. P., Hennick, C. C., Sebastian, T., Woolston, M. R., Perreault, D. J., & Barrett, S. R. H. “Flight of an aeroplane with solid-state propulsion” Nature, 563, 532-536 (2018)
Nowakowska, H., Lackowski, M., Ochrymiuk, T., and Szwaba, R., “Novel electrostatic wind energy converter: an overview”, TASK QUARTERLY, 19, No 2, pp. 207-218, (2015).
Carmein, D., and White, D. “Electro-hydrodynamic wind energy system”, U.S. Pat. No. 8,421,047 (2013).
Carmein, D., White, D. “Electro-hydrodynamic wind energy system”, U.S. Pat. No. 8,878,150 (2014).
Djairam, D., “The Electrostatic Wind Energy Converter”, Ph.D. thesis Delft University of Technology (2008).
Marks, A. M. “Optimum Charged Aerosols for Power Conversion” J. Applied Phys. 43,219 (1972).
Gregory, S. E., Schurig, A. K., Apparatus and method of generating electricity from wind energy, U.S. Pat. No. 4,146,800 (1979).
Chen, J. and Davidson, J. H., “Electron Density and Energy Distributions in the Positive DC Corona: Interpretation for Corona-Enhanced Chemical Reactions”, Plasma Chem. Plasma Process. 22, 199-224 (2002).
Chen, J., and Davidson, J. H., “Model of the negative DC corona plasma: comparison to the positive DC corona plasma”, Plasma Chemistry and Plasma Processing, 23, 83-102, (2003).
Sigmond, R. S., “Simple approximate treatment of unipolar space-charge-dominated coronas: The Warburg law and the saturation current”, JAP, 53, 891 (1982).
Betz, A. Introduction to the Theory of Flow Machines. (D. G. Randall, Trans.) Oxford: Pergamon Press (1966).

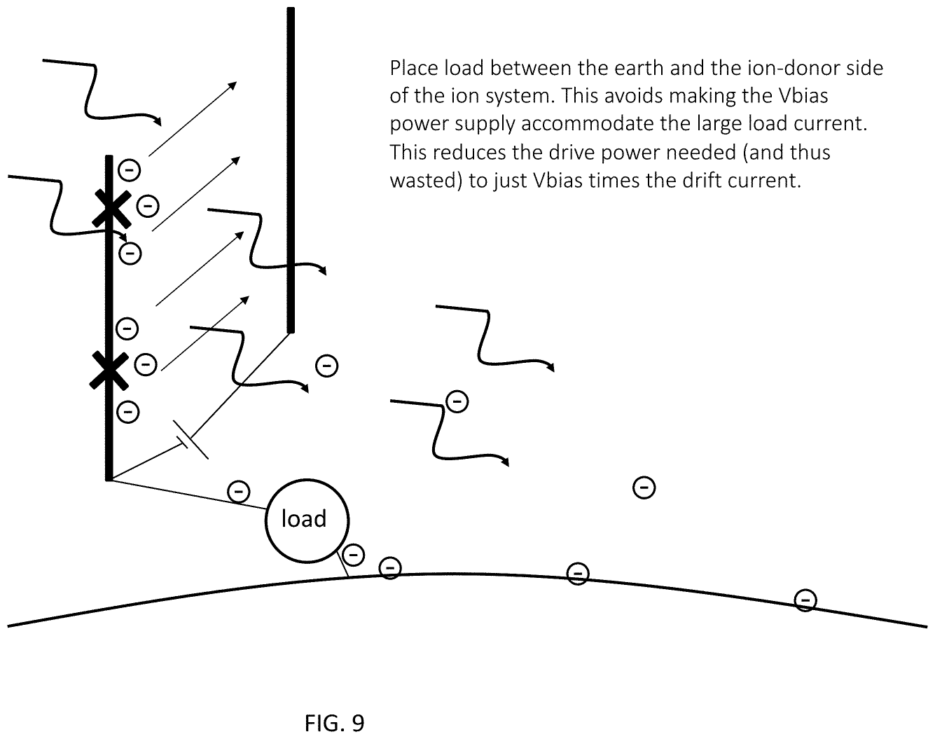

FIG. 9 is a schematic illustration of an example embodiment of the present invention. The load is between the earth and the ion-donor side (emitter) of the ion system. This avoids making the Vbias power supply accommodate the large load current. This reduces the drive power needed (and thus wasted) to just Vbias times the drift current.

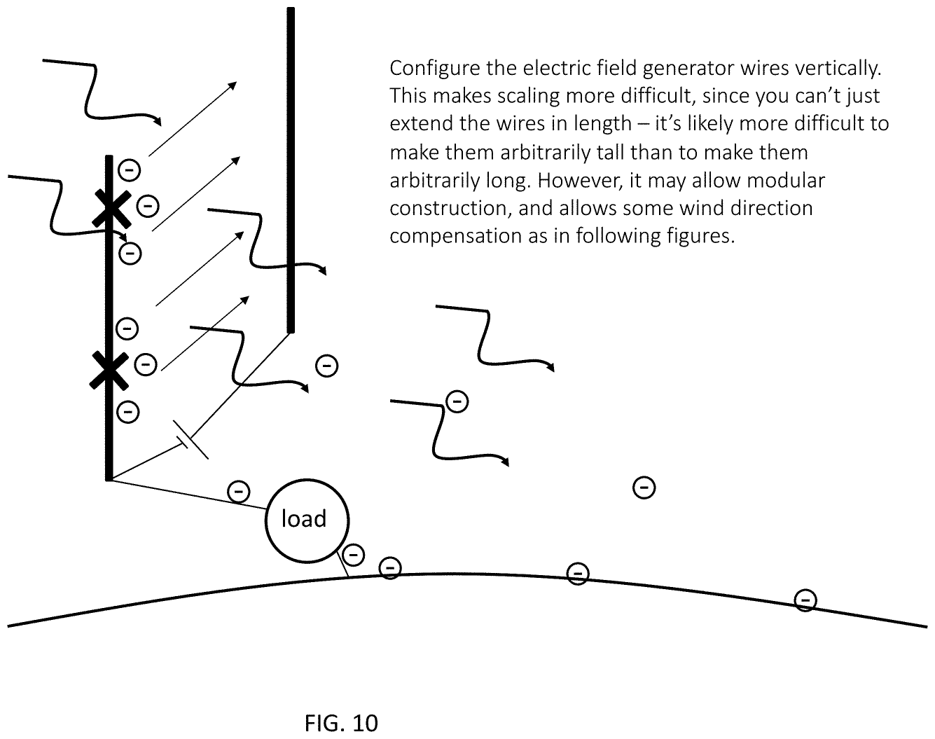

FIG. 10 is a schematic illustration of an example embodiment of the present invention. The electric field/ion generator wires are disposed vertically. This makes scaling more difficult, since you can't just extend the wires in length—it's likely more difficult to make them arbitrarily tall than to make them arbitrarily long. However, it allows modular construction, and allows some wind direction compensation as in following figures.

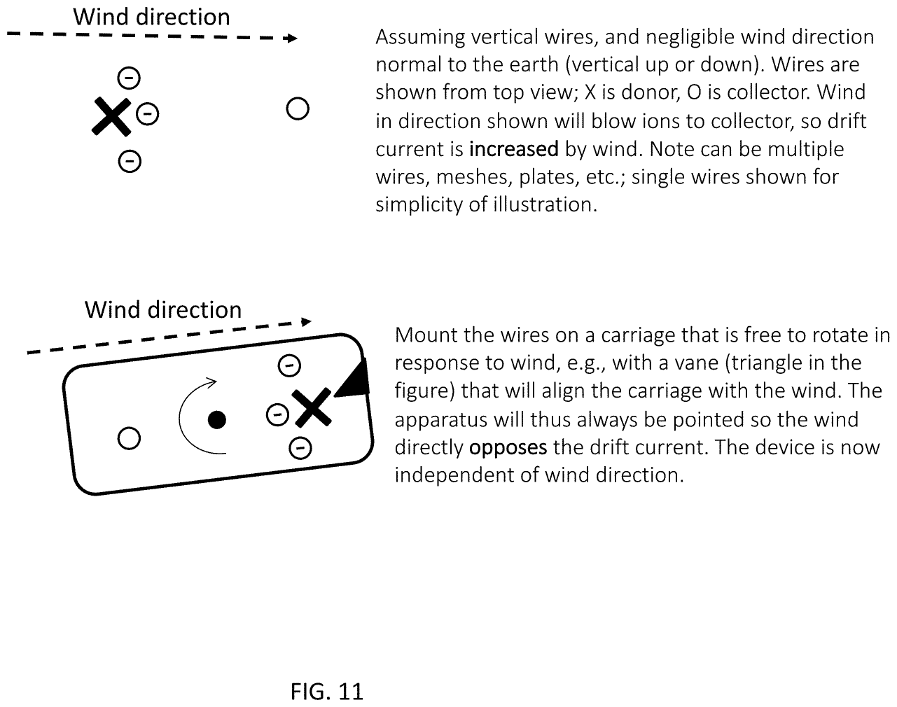

FIG. 11 is a schematic illustration of an example embodiment of the present invention. Assuming vertical wires, and negligible wind direction normal to the earth (vertical up or down). Wires are shown from top view; X is donor, O is collector. Wind in direction shown will blow ions to collector, so drift current is increased by wind. Note can be multiple wires, meshes, plates, etc.; single wires shown for simplicity of illustration. Mount the wires on a carriage that is free to rotate in response to wind, e.g., with a vane (triangle in the figure) that will align the carriage with the wind. The apparatus will thus always be pointed so the wind directly opposes the drift current. The device is now independent of wind direction.

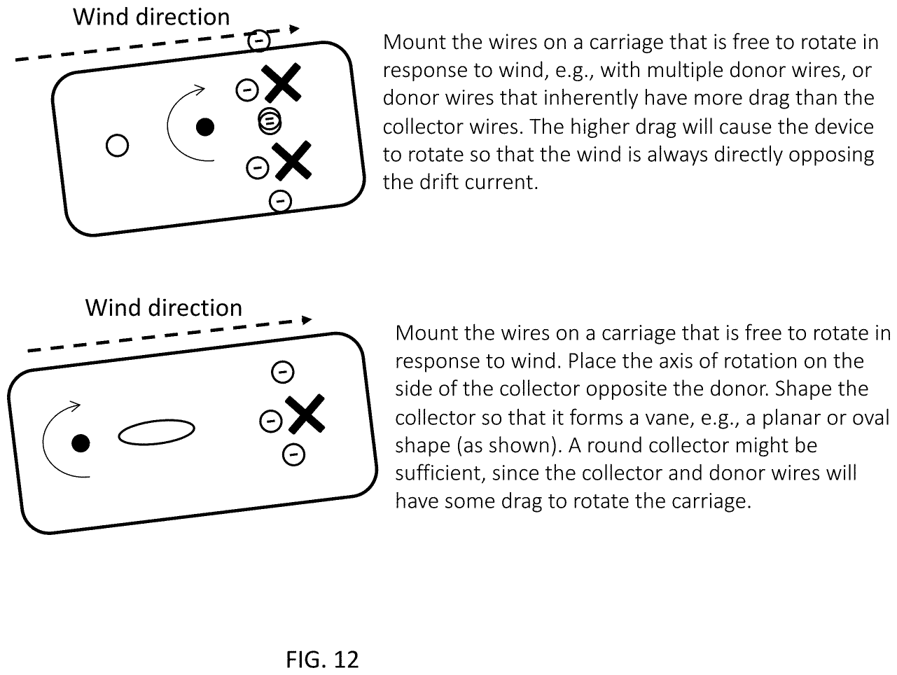

FIG. 12 is a schematic illustration of an example embodiment of the present invention. Mount the wires on a carriage that is free to rotate in response to wind, e.g., with multiple donor wires, or donor wires that inherently have more drag than the collector wires. The higher drag will cause the device to rotate so that the wind is always directly opposing the drift current. Mount the wires on a carriage that is free to rotate in response to wind. Place the axis of rotation on the side of the collector opposite the donor. Shape the collector so that it forms a vane, e.g., a planar or oval shape (as shown). A round collector might be sufficient, since the collector and donor wires will have some drag to rotate the carriage.

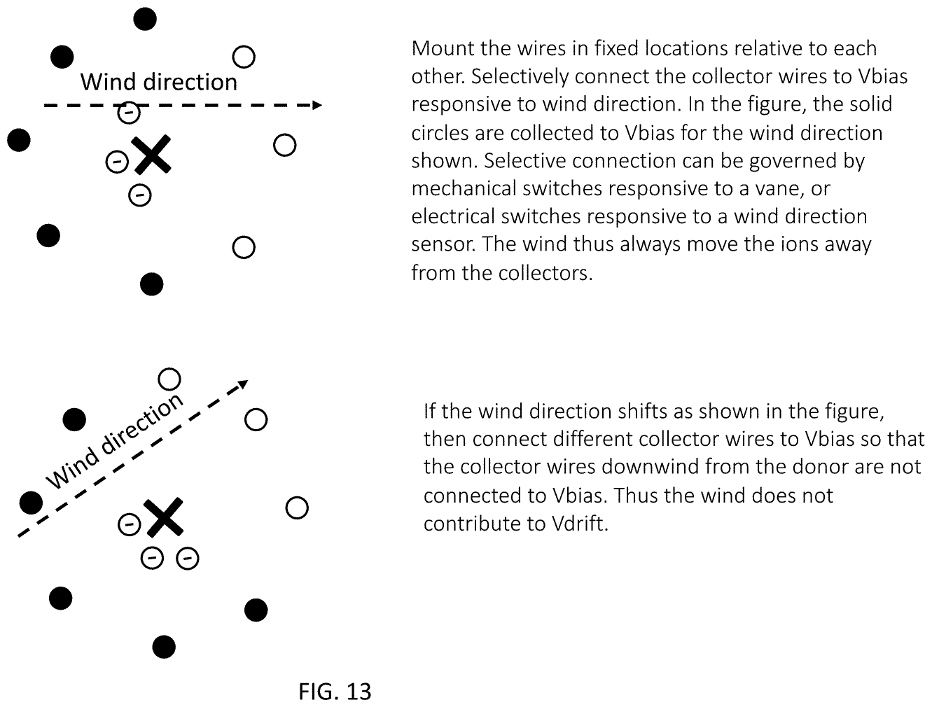

FIG. 13 is a schematic illustration of an example embodiment of the present invention. Mount the wires in fixed locations relative to each other. Selectively connect the collector wires to Vbias responsive to wind direction. In the figure, the solid circles are collected to Vbias for the wind direction shown. Selective connection can be governed by mechanical switches responsive to a vane, or electrical switches responsive to a wind direction sensor. The wind thus always move the ions away from the collectors. If the wind direction shifts as shown in the figure, then connect different collector wires to Vbias so that the collector wires downwind from the donor are not connected to Vbias. Thus the wind does not contribute to Vdrift.

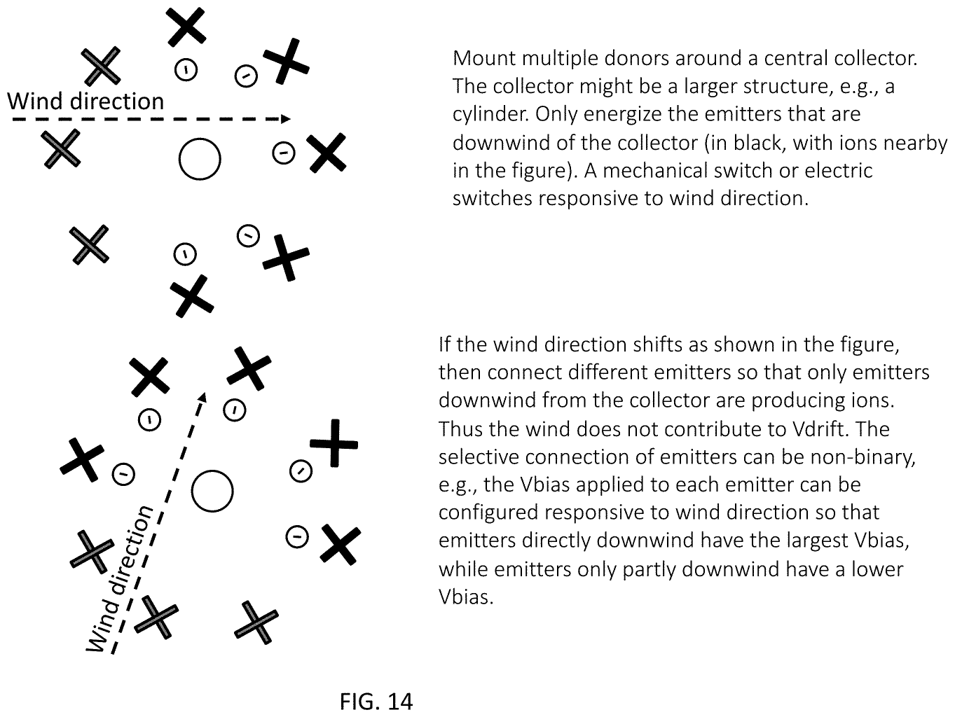

FIG. 14 is a schematic illustration of an example embodiment of the present invention. Mount multiple donors around a central collector. The collector might be a larger structure, e.g., a cylinder. Only energize the emitters that are downwind of the collector (in black, with ions nearby in the figure). A mechanical switch or electric switches responsive to wind direction. If the wind direction shifts as shown in the figure, then connect different emitters so that only emitters downwind from the collector are producing ions. Thus the wind does not contribute to Vdrift. The selective connection of emitters can be non-binary, e.g., the Vbias applied to each emitter can be configured responsive to wind direction so that emitters directly downwind have the largest Vbias, while emitters only partly downwind have a lower Vbias.

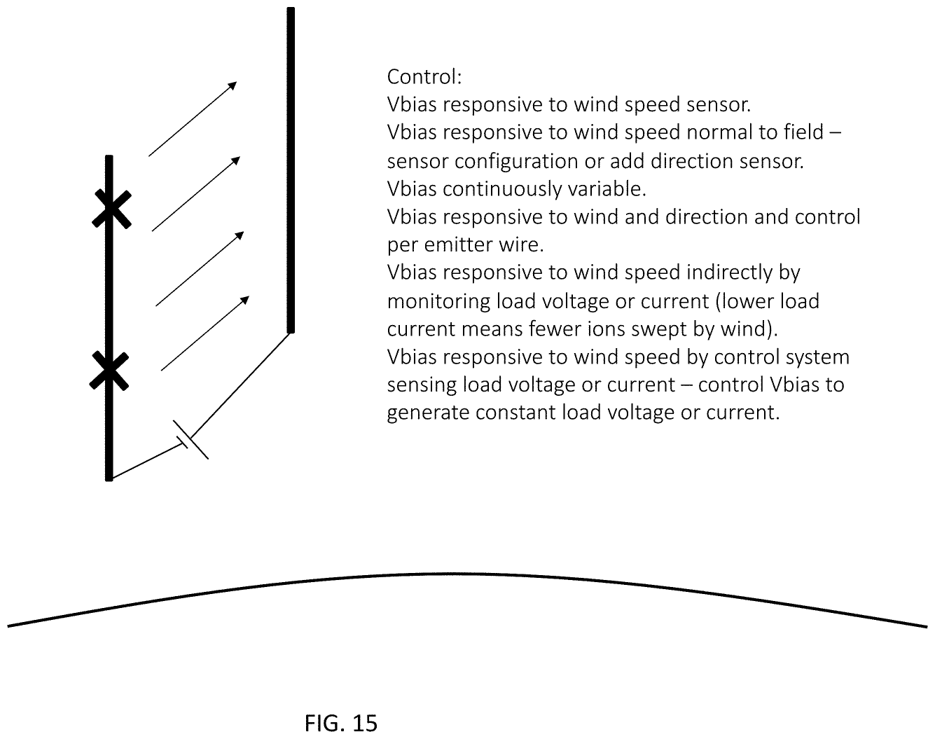

FIG. 15 is a schematic illustration of an example embodiment of the present invention. Vbias can be controlled according to any of the following:

Vbias responsive to wind speed sensor.
Vbias responsive to wind speed normal to field-sensor configuration or add direction sensor.
Vbias continuously variable.
Vbias responsive to wind and direction and control per emitter wire.
Vbias responsive to wind speed indirectly by monitoring load voltage or current (lower load current means fewer ions swept by wind).
Vbias responsive to wind speed by control system sensing load voltage or current-control Vbias to generate constant load voltage or current.

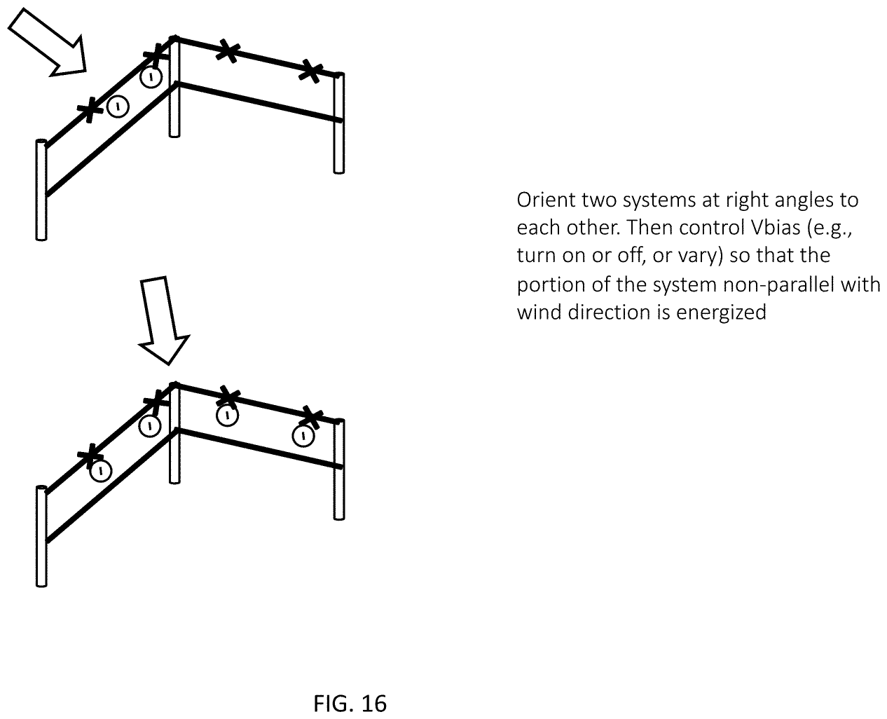

FIG. 16 is a schematic illustration of an example embodiment of the present invention. Orient two systems at right angles to each other. Then control Vbias (e.g., turn on or off, or vary) so that the portion of the system non-parallel with wind direction is energized

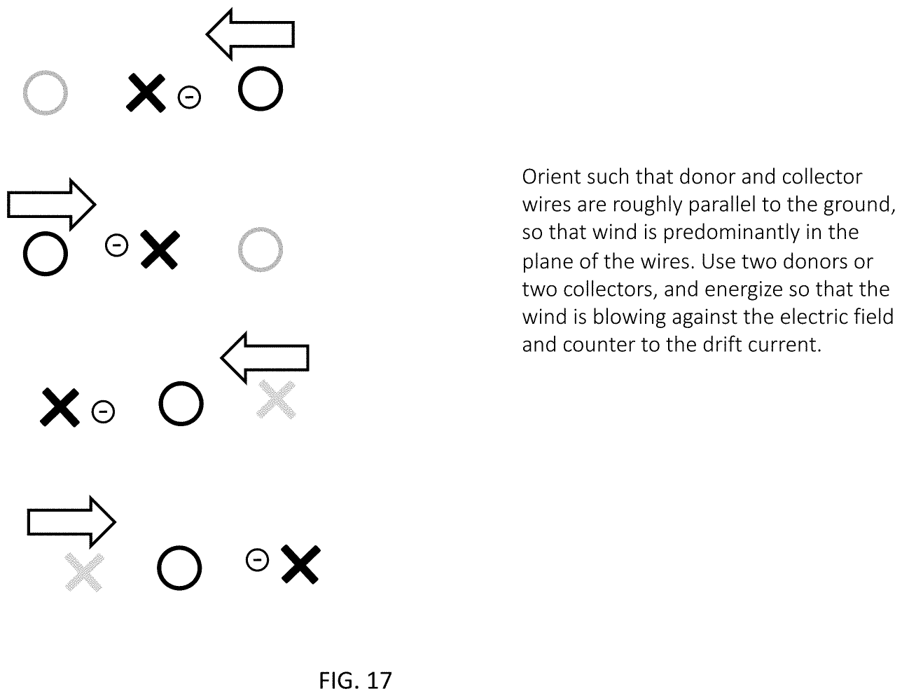

FIG. 17 is a schematic illustration of an example embodiment of the present invention. Orient such that donor and collector wires are roughly parallel to the ground, so that wind is predominantly in the plane of the wires. Use two donors or two collectors, and energize (black are energized; grey are not energized in the figure) so that the wind is blowing against the electric field and counter to the drift current. The figure illustrates energizing the collectors as the wind shifts direction: from the right in the top illustration, then reverses in the second from the top, etc.

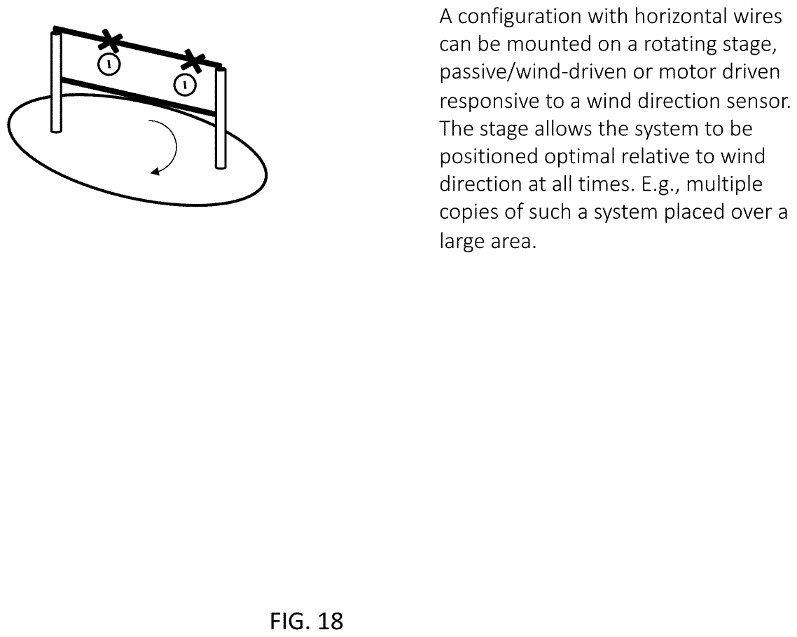

FIG. 18 is a schematic illustration of an example embodiment of the present invention. A configuration with horizontal wires can be mounted on a rotating stage, passive/wind-driven or motor driven responsive to a wind direction sensor. The stage allows the system to be positioned optimal relative to wind direction at all times. E.g., multiple copies of such a system placed over a large area.

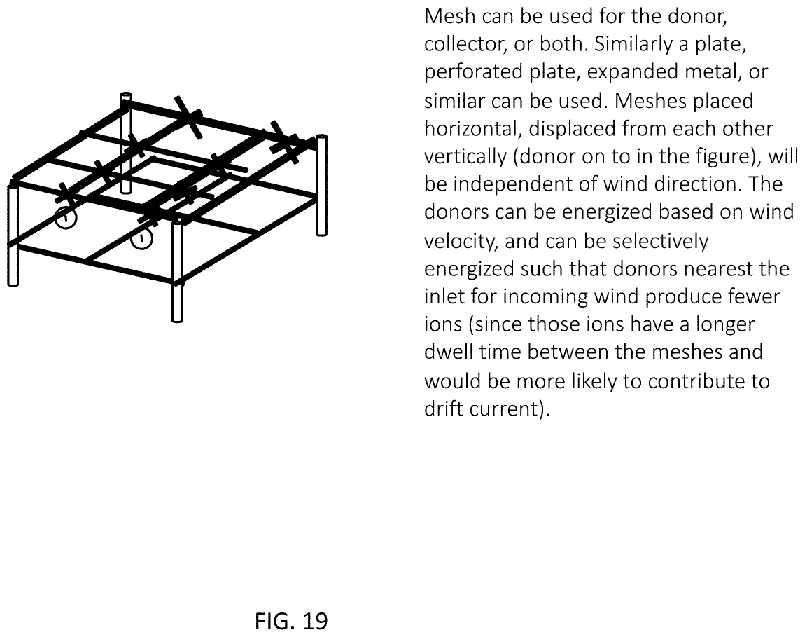

FIG. 19 is a schematic illustration of an example embodiment of the present invention. Mesh can be used for the donor, collector, or both. Similarly a plate, perforated plate, expanded metal, or similar can be used. Meshes placed horizontal, displaced from each other vertically (donor on to in the figure), will be independent of wind direction. The donors can be energized based on wind velocity, and can be selectively energized such that donors nearest the inlet for incoming wind produce fewer ions (since those ions have a longer dwell time between the meshes and would be more likely to contribute to drift current).

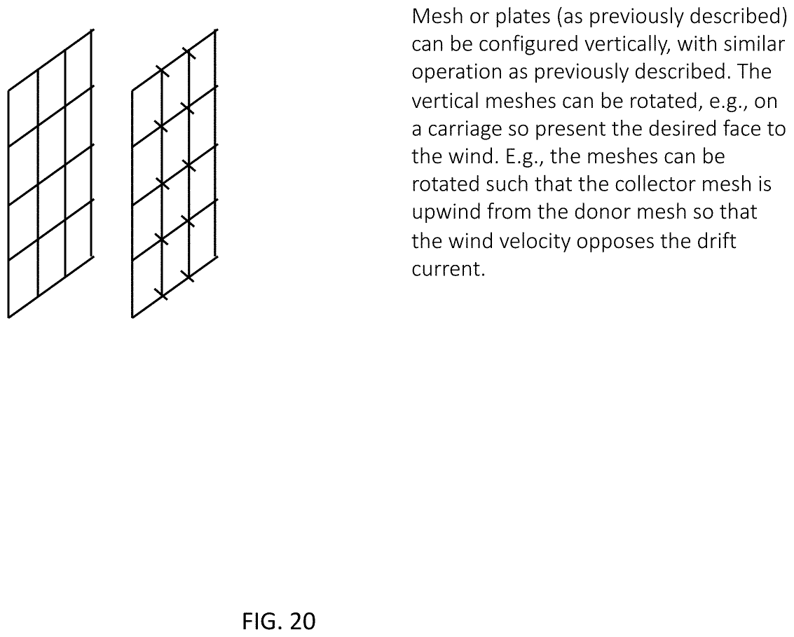

FIG. 20 is a schematic illustration of an example embodiment of the present invention. Mesh or plates (as previously described) can be configured vertically, with similar operation as previously described. The vertical meshes can be rotated, e.g., on a carriage so present the desired face to the wind. E.g., the meshes can be rotated such that the collector mesh is upwind from the donor mesh so that the wind velocity opposes the drift current. The mesh can be oriented so that the wind blows through the gap, parallel to the planes of the mesh. The mesh can be oriented so that the wind blows through the openings in the mesh, normal to the planes of the mesh.

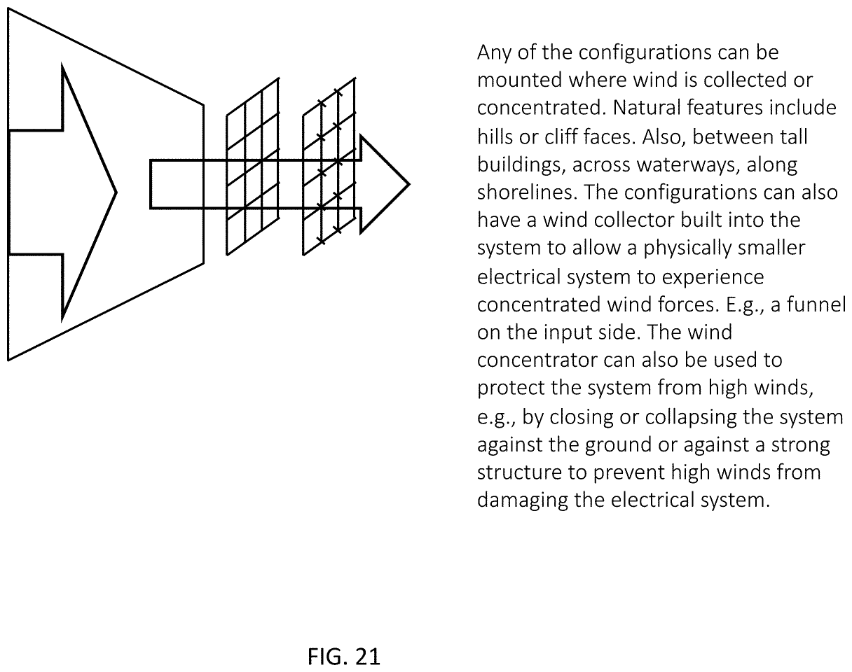

FIG. 21 is a schematic illustration of an example embodiment of the present invention. Any of the configurations can be mounted where wind is collected or concentrated. Natural features include hills or cliff faces. Also, between tall buildings, across waterways, along shorelines. The configurations can also have a wind collector built into the system to allow a physically smaller electrical system to experience concentrated wind forces. E.g., a funnel on the input side. The wind concentrator can also be used to protect the system from high winds, e.g., by closing or collapsing the system against the ground or against a strong structure to prevent high winds from damaging the electrical system.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

We claim:

1. An electrical energy generation system comprising:
(a) an emitter subsystem comprising one or more emitters configured to encourage ions in the air proximal the emitter;
(b) a collector subsystem comprising one or more electrical conductors, spaced apart from the emitter subsystem such that air movement encourages ions to settle on an environmental surface other than the emitter and collector subsystems;
(c) a drive subsystem comprising a source of electrical energy in electrical communication with the emitter subsystem and the collector subsystem, where the drive subsystem produces sufficient electrical energy to produce ions from the emitters;
(d) load connections for an electrical load between either (a) the electrical potential of the collector subsystem or (b) the electrical potential of the emitter subsystem; and the electrical potential of the environmental surface.

2. The system of claim 1, wherein the connections for the electrical load are between the electric potential of the collector subsystem and the electrical potential of the environmental surface.

3. The system of claim 1, wherein the connections for the electrical load are between the electric potential of the emitter subsystem and the electrical potential of the environmental surface.

4. The system of claim 1, wherein the environmental surface is the earth.

5. The system of claim 1, wherein emitter subsystem comprises one or more electrically conductive wires, each having one or more corona-encouraging structures comprising one or more barbs or tufts having a plurality of sharp points.

6. The system of claim 1, wherein the collector subsystem comprises a plurality of electrically conductive collector wires disposed parallel to and spaced apart from each other, and the emitter subsystem comprises a plurality of electrically conductive emitter wires disposed substantially parallel to and spaced apart from each other and from the collector wires.

7. The system of claim 6, wherein the number of collector wires is twice the number of emitter wires.

8. The system of claim 6, wherein the collector wires and emitter wires are disposed with a vertical separation between them.

9. The system of claim 1, wherein the drive subsystem produces electrical energy whose magnitude varies responsive to one or more of: wind speed, wind direction, voltage across the load connections, current through the load connections.

10. The system of claim 1, wherein the collector subsystem comprises a plurality of electrical conductors spaced apart from each other, and wherein a subset of the electrical conductors can be placed into communication with, or isolated from, the drive subsystem.

11. The system of claim 11, wherein electrical conductors downwind of the emitter subsystem are isolated from the drive subsystem.

12. The system of claim 1, wherein the emitter subsystem comprises a plurality of electrical conductors spaced apart from each other, and wherein a subset of the electrical conductors can be placed into communication with, or isolated from, the drive subsystem.

13. The system of claim 12, wherein electrical conductors upwind of the collector subsystem are isolated from the drive subsystem.

14. The system of claim 1, wherein the collector subsystem comprises a collector mesh of electrically conductive material, and wherein the emitter subsystem comprises an emitter mesh of electrically conductive material disposed substantially parallel to and spaced apart from the collector mesh.

15. The system of claim 1, wherein the collector mesh is disposed substantially parallel to the earth's surface.

16. The system of claim 15, wherein the drive subsystem is configured to supply electrical energy to the emitter mesh at a magnitude that varies based on position in the mesh.

17. The system of claim 16, wherein the drive subsystem is configured to supply electrical energy of lesser magnitude in regions of the emitter mesh near where wind impinges on the emitter mesh than in regions of the emitter mesh far from where wind impinges on the emitter mesh.

18. The system of claim 1, wherein the relative positions of the emitter subsystem and the collector subsystem are changed responsive to wind conditions.

19. The system of claim 18, wherein the emitter subsystem is moveable to maintain the emitter subsystem downwind from the collector subsystem.

20. An electrical energy generation system comprising:
(a) a plurality of coronae emitters configured to produce ions;
(b) one or more electrically conductive collectors;
(c) an input power source, connected to the emitters and the collectors to maintain an electrical potential difference there between;
(d) connections for an electrical load between the collectors and the earth ground.
